(19) United States
(12) Patent Application Publication
(10) Pub. No.: US 2021/0102022 A1
(43) Pub. Date: Apr. 8, 2021

(54) METHOD FOR PRODUCING A DIENE ELASTOMER MODIFIED WITH A 1,3-DIPOLAR COMPOUND BY MEANS OF REACTIVE EXTRUSION

(71) Applicant: COMPAGNIE GENERALE DES ETABLISSEMENTS MICHELIN, Clemont-Ferrand (FR)

(72) Inventor: Rokhiyatou SAID-DIATTA, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/468,885

(22) PCT Filed: Dec. 19, 2017
(86) PCT No.: PCT/FR2017/053677

§ 371 Date: Jun. 12, 2019

(30) Foreign Application Priority Data
Dec. 19, 2016 (FR) 1662762

(51) Int. Cl. C08F 279/02; C08K 5/315; C08F 2/01; C08F 8/32; B29B 7/00; B29B 7/60; B29B 15/08; B29B 7/74; B29B 9/02

(52) U.S. Cl. CPC C08F 279/02; C08K 5/315; C08F 2/01; C08F 8/32; B29B 9/02; B29B 7/60; B29B 15/08; B29B 7/7485; B29B 7/005

(57) ABSTRACT

A process for the preparation of a diene elastomer modified by a 1,3-dipolar compound is provided. The process includes reactive extrusion of a mixture of a diene elastomer and of a 1,3-dipolar compound in a twin-screw extruder at an extrusion temperature of greater than 100° C. Such a process is reproducible and makes possible good control of the grafting reaction.

This application is a 371 national phase entry of PCT/FR2017/053677 filed on 19 Dec. 2017, which claims benefit of French Patent Application No. 1662762, filed 19 Dec. 2016, the entire contents of which are incorporated herein by reference for all purposes.

### BACKGROUND

### 1. Technical Field

The present invention relates to a process for the modification of a diene elastomer by a reaction of grafting a 1,3-dipolar compound.

### 2. Related Art

The modification of diene elastomer with a 1,3-dipolar compound is known. The modification takes place by a [3+2]-cycloaddition reaction of the 1,3-dipolar compound with the double bonds of the diene units of the elastomer. Very often, the 1,3-dipolar compound used is a compound which, besides the dipole, bears a chemical functional group which makes it possible to graft pendant chemical functional groups to the elastomer. Such modified elastomers can be intended for use in tyre rubber compositions. These modification reactions can be carried out in solution or in bulk, for example in an internal mixer, such as is described, for example, in the documents WO 2012007442, WO 2015059271 and WO 2015177105. When the modified elastomer is intended to be used in a rubber composition comprising a reinforcing filler and when several tens or hundreds of kilograms of diene elastomer are modified in an internal mixer by thermomechanical kneading of the diene elastomer and of the 1,3-dipolar compound, the modification reaction is followed by the addition and by the incorporation of the reinforcing filler and optionally of the other ingredients of the composition. The combination is mixed by thermomechanical kneading in the internal mixer and then the filler-comprising mixture is dropped in order to recover it. In the dropping, it is found that the filler-comprising mixture falls as a powder, which makes it very difficult to use the filler-comprising mixture for the subsequent stages of preparation of the rubber composition. It is also found that the grafting yield is fluctuating and may reach relatively low values.

### SUMMARY

The Applicant Companies, continuing their efforts, have found a novel bulk process which makes it possible to obtain high and substantially constant grafting yields in the case where large amounts of elastomer are modified.

A subject-matter of the invention is thus a process for the preparation of a diene elastomer modified by a 1,3-dipolar compound by a grafting reaction, characterized in that it comprises a stage a) of reactive extrusion of a mixture of a diene elastomer and of a 1,3-dipolar compound in a twin-screw extruder comprising a barrel, a set of two endless screws, a feed zone, a compounding zone and a die, the extrusion temperature being greater than 100° C.

Another subject-matter of the invention is a process for the preparation of a rubber composition based on a diene elastomer modified by a 1,3-dipolar compound and on a reinforcing filler which comprises the following stages:
a stage a) of reactive extrusion of a mixture of a diene elastomer and of a 1,3-dipolar compound in a twin-screw extruder comprising a barrel, a set of two endless screws, a feed zone, a compounding zone and a die in order to form a modified diene elastomer, the extrusion temperature being greater than 100° C.,
a stage of incorporation of a reinforcing filler in the modified diene elastomer by thermomechanical kneading in an internal mixer.

Another subject-matter of the invention is a granule of diene elastomer modified by a reaction of grafting a 1,3-dipolar compound capable of being obtained by the process in accordance with the invention in which stage a) is followed by a stage of granulation of the modified diene elastomer.

Another subject-matter of the invention is the use of granules in accordance with the invention in a rubber composition comprising a reinforcing filler.

### I. DETAILED DESCRIPTION OF EXAMPLE EMBODIMENTS

In the present description, unless expressly indicated otherwise, all the percentages (%) shown are % by weight. The abbreviation “phr” means parts by weight per hundred parts of elastomer (of the total of the elastomers, if several elastomers are present).

Any interval of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tyres) being capable of reacting or intended to react with one another, at least in part, during the various phases of manufacture of the composition intended for the manufacture of tyres.

The compounds mentioned in the description can be of fossil or biobased origin. In the latter case, they may partially or completely result from biomass or be obtained from renewable starting materials resulting from biomass. Polymers and 1,3-dipolar compounds are concerned in particular.

A “diene” elastomer (or without distinction rubber) should be understood, in a known way, as meaning an elastomer (or several elastomers) composed, at least in part (i.e., a homopolymer or a copolymer), of diene monomer units (monomers bearing two conjugated or non-conjugated carbon-carbon double bonds).

Given these definitions, diene elastomer capable of being used in the compositions in accordance with the invention is understood more particularly to mean:

(a) any homopolymer of a conjugated diene monomer, in particular any homopolymer obtained by polymerization of a conjugated diene monomer having from 4 to 12 carbon atoms;

(b) any copolymer obtained by copolymerization of one or more conjugated dienes with one another or with one or more vinylaromatic compounds having from 8 to 20 carbon atoms;

(c) any ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;

(e) any copolymer obtained by copolymerization of one or more conjugated dienes with ethylene, an acyclic aliphatic α-monoolefin having from 3 to 18 carbon atoms or their mixture, such as, for example, those described in the documents WO 2005/028526, WO 2004/035639 and WO 2007/054224.

Preferably, the diene elastomer is selected from the group consisting of polybutadienes, polyisoprenes, butadiene copolymers, isoprene copolymers and their mixtures. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and copolymers of ethylene and of butadiene. More preferably, the diene elastomer is a polyisoprene comprising more than 90 mol % of cis-1,4-bonding. Synthetic polyisoprenes having such a microstructure may very particularly be suitable.

The diene elastomer preferably contains an antioxidant. The antioxidant can be any antioxidant, in particular any antioxidant conventionally used to protect diene elastomers. Of course, the antioxidant can be a mixture of several antioxidants. Mention may be made, for example, of the antioxidants belonging to the family of the phenols, of the amines, of the quinones, of the tocopherols, of the tocotrienols or of the thiols. By way of example, para-phenylenediamine derivatives, also denoted in a known way as substituted para-phenylenediamines, such as, for example, N-(1,3-dimethylbutyl)-N′-phenyl-p-phenylenediamine (better known under the abbreviation “6-PPD”), N-isopropyl-N′-phenyl-p-phenylenediamine (abbreviated to “I-PPD”), phenyl-cyclohexyl-p-phenylenediamine, N,N′-di(1,4-dimethylpentyl)-p-phenylenediamine, N,N′-diaryl-p-phenylenediamine (“DTPD”), diaryl-p-phenylenediamine (“DAPD”), 2,4,6-tris-(N-1,4-dimethylpentyl-p-phenylenediamino)-1,3,5-triazine and the mixtures of such diamines, quinoline derivatives (“TMQ”), such as, for example, 1,2-dihydro-2,2,4-trimethylquinoline and 6-ethoxy-1,2-dihydro-2,2,4-trimethylquinoline, phenol derivatives, in particular cresol derivatives, such as 2,2′-methylenebis(6-(tert-butyl)-4-methylphenol), known under the name of “A02246”, or copolymers of dicyclopentadiene and of para-cresol, in particular the antioxidant “Struktol LA229” from Schill & Seilacher, or substituted diphenylamine or triphenylamine derivatives, such as described, for example, in Applications WO 2007/121936, WO 2008/055683 and WO2009/138460, in particular 4,4′-bis(isopropylamino)triphenylamine, 4,4′-bis(1,3-dimethylbutylamino)triphenylamine, 4,4′-bis(1,4-dimethylpentylamino)triphenylamine, 4,4′,4″-tris(1,3-dimethylbutylamino)triphenylamine or 4,4′,4″-tris(1,4-dimethylpentylamino)triphenylamine, are suitable.

Typically, the content of antioxidant is between 1 and 20 phr. The presence of antioxidant in the diene elastomer makes it possible to minimize, indeed even to limit, the changes in macrostructure of the diene elastomer which might result from the passage of the diene elastomer through the extruder. The maximum content of antioxidant to be introduced into the diene elastomer can be justified for economic reasons, namely to minimize the cost related to the price of the antioxidant.

The diene elastomer can be an extended elastomer. The term “extended elastomer” is understood to mean an elastomer to which a plasticizer has been added, in particular conventionally, for example in the process for finishing the diene elastomer. Mention be be made, by way of plasticizer, of the extender oils conventionally used in tyre rubber compositions, such as naphthenic oils, paraffinic oils, DAE oils, MES (Medium Extracted Solvates) oils, TDAE (Treated Distillate Aromatic Extracts) oils, RAE (Residual Aromatic Extracts) oils, TRAE (Treated Residual Aromatic Extracts) oils and SRAE (Safety Residual Aromatic Extracts) oils, mineral oils.

The term “1,3-dipolar compound” is understood according to the definition given by the IUPAC. The dipole of the 1,3-dipolar compound can be a nitrile oxide, a nitrone or a nitrilimine and is preferably a nitrile oxide.

When the dipole of the 1,3-dipolar compound is a nitrile oxide, the 1,3-dipolar compound preferably comprises a benzene ring which is substituted by the dipole. More preferably, the benzene ring is also substituted in the position ortho to the dipole. These preferred embodiments make it possible to optimize the grafting yield even more. This is because the presence of the benzene ring in the structure of the 1,3-dipolar compound, in particular substituted in the ortho position, confers a better stability on the 1,3-dipolar compound on storage before it is brought into contact with the diene elastomer.

The 1,3-dipolar compound, besides the dipole, can bear another chemical functional group.

Mention may be made, as chemical functional group, of the groups which can join together by hydrogen bonds, such as those described in the document WO 2012007441, very particularly the groups containing a 5-membered dinitrogenous and carbonylated heterocycle, such as the 2-oxoimidazolidin-1-yl group, it being possible for the groups to interact with the surface of a reinforcing filler conventionally used in tyre rubber compositions, such as imidazole, ester, oxazoline, thiazoline, alkoxysilane and allyltin groups, as respectively described in the documents WO 2015059271, WO2015177105 and WO 2006045088.

The amount of 1,3-dipolar compound in the mixture of diene elastomer and of 1,3-dipolar compound, expressed in moles per 100 moles of elastomer units, can vary to a great extent, for example within a range of between 0.01 and 50, preferably from 0.01 to 3. It is indexed to the grafting yield and the degree of grafting desired on the diene elastomer, which depends on the application envisaged for the modified diene elastomer.

The process in accordance with the invention has the essential characteristic of comprising a stage of reactive extrusion of the mixture of the diene elastomer and of the 1,3-dipolar compound. This stage is referred to as stage a). The extruder of use for the requirements of the invention is a twin-screw extruder. Conventionally, it comprises a barrel, a feed zone, a compounding zone, a set of two endless screws and a die.

The diene elastomer and the 1,3-dipolar compound are introduced into the feed zone of the extruder, typically via the hopper. While feeding the extruder with diene elastomer, the 1,3-dipolar compound is simultaneously introduced.

Alternatively, the diene elastomer and the 1,3-dipolar compound are introduced separately into the extruder, the introduction of the diene elastomer being carried out in the feed zone of the extruder, the introduction of the 1,3-dipolar compound being carried out downstream of the introduction of the diene elastomer. Typically, the extruder is fed with diene elastomer via the feed hopper which conventionally equips an extruder. The 1,3-dipolar compound is preferably introduced into the compounding zone of the extruder, conventionally downstream of the feed zone. This alternative is advantageous as it makes possible a more homogeneous distribution of the 1,3-dipolar compound in the diene elastomer. It follows that the degree of grafting of the diene elastomer virtually does not fluctuate at the die outlet.

In the extruder, the diene elastomer warms up under the effect of the mechanical stresses, in particular in the compounding zone. Additional heat, for example contributed by a heat-exchange fluid circulating in a jacket of the extruder, may be necessary in order to increase the extrusion temperature even more. The term “extrusion temperature” refers to the set temperature applied inside the extruder, in particular in the barrel. The extrusion temperature is greater than 100° C. Preferably, the extrusion temperature is between 110 and 140° C. More preferably still, the extrusion temperature in the zone ranging from the compounding zone up to the end of the set of the two screws closest to the die is between 110° C. and 140° C. Such a temperature range makes it possible to obtain the best compromise between the grafting yield and the productivity. The productivity is governed by the flow rate of the diene elastomer in the extruder, which is itself adjusted as a function of the residence time which it is desired to apply to the diene elastomer in the extruder from the compounding zone up to the die of the extruder.

The residence times are typically short, in particular of at most 5 minutes, preferably less than 5 minutes. Residence times ranging from 30 seconds to 2 minutes may be sufficient to obtain both a good grafting yield and good control of the degree of grafting, which guarantees good reproducibility of the process. These process performance qualities are produced without being to the detriment of the properties of the diene elastomer, since the implementation of the process is not accompanied by crosslinking of the diene elastomer. The process in accordance with the invention makes it possible to extrude without applying specific conditions with regard to the atmosphere inside the barrel. Typically, the extrusion takes place under ambient air. At the outlet of the extruder, after passing through the die, the modified diene elastomer is recovered. The modified diene elastomer is a diene elastomer, the diene units of which have reacted by a [3+2]-cycloaddition reaction with the 1,3-dipolar compound.

At the outlet of the extruder, the modified diene elastomer is preferably cut up into granules according to a granulation stage, a stage well known to a person skilled in the art. Any device known for cutting up diene elastomers in processes for the manufacture of synthetic rubbers can be used, such as a hammer or a granulator. It is positioned after the die. In order to be able to conserve the granules without them agglomerating, it is possible to put talc on the granules and then, if need be, to place them in a suitable packaging in order to be able to transport them, store them or handle them.

The granules capable of being obtained according to the process in accordance with the invention can be used as elastomer in a rubber composition comprising a reinforcing filler.

The reinforcing filler can be any type of “reinforcing” filler known for its abilities to reinforce a rubber composition which can be used for the manufacture of tyres, for example an organic filler, such as carbon black, a reinforcing inorganic filler, such as silica, with which is combined, in a known way, a coupling agent, or also a mixture of these two types of filler. Such a reinforcing filler typically consists of nanoparticles, the (weight-) average size of which is less than a micrometre, generally less than 500 nm, most often between 20 and 200 nm, in particular and more preferably between 20 and 150 nm.

The process for the preparation of the rubber composition has the essential characteristic of comprising the stage a) defined according to any one of the embodiments for the preparation of the modified diene elastomer. It additionally comprises a stage of incorporation of the reinforcing filler in the modified and extruded diene elastomer, preferably in the form of granules, in an internal mixer. A stage of granulation of the modified diene elastomer can follow stage a) and precede the stage of incorporation of the reinforcing filler.

The stage of incorporation of the reinforcing filler in the modified and extruded diene elastomer can be carried out in a way known to a person skilled in the art and conventionally by carrying out a high-temperature thermomechanical kneading (“non-productive” phase) up to a maximum temperature of between 110° C. and 200° C., preferably between 130° C. and 185° C. During this “non-productive” phase, all the constituents necessary for the rubber composition, with the exception of the crosslinking system, can also be introduced into the internal mixer. The total duration of the kneading, in this non-productive phase, is preferably between 2 and 10 min. After cooling the mixture thus obtained during the first non-productive phase, the crosslinking system is then incorporated at low temperature, generally in an external mixer, such as an open mill; everything is then mixed (productive phase) for a few minutes, for example between 5 and 15 min.

The final composition thus obtained is subsequently calendered, for example in the form of a sheet or of a plaque, in particular for a laboratory characterization, or also extruded in the form of a rubber profiled element which can be used, for example, as tyre semi-finished article, such as a tyre tread.

The abovementioned characteristics of the present invention, and also others, will be understood more clearly on reading the following description of the implementational examples of the invention, given by way of illustration and without limitation.

### II. IMPLEMENTATIONAL EXAMPLES OF THE INVENTION

II.1-Examples not in Accordance with the Invention:

The modified diene elastomers and also the rubber compositions containing them are prepared according to a process not in accordance with the invention but according to the following process described in the state of the art, in the case in point the document WO 2012007442.

Stage 1: 150 kg of diene elastomer and a targeted amount of 1,3-dipolar compound are introduced into an internal mixer, the initial vessel temperature of which is approximately 50° C. Mixing is carried out by thermomechanical kneading for 2 minutes, up to a temperature of 120° C.

Stage 2: The reinforcing filler (silica, 60 phr; carbon black N234: 3 phr), the coupling agent (Si69, 6 phr) and then, after kneading for one to two minutes, the various other ingredients (antioxidant: 3 phr; paraffin: 1 phr; stearic acid: 2.5 phr; ZnO: 3 phr), with the exception of the vulcanization system, are introduced into the internal mixer containing the modified diene elastomer. Thermomechanical working is then carried out (non-productive phase) in one stage (total duration of the kneading equal to approximately 5 min), until a maximum “dropping” temperature of 160° C. is reached. The rubber composition thus obtained (composition NC1) is recovered.

The 1,3-dipolar compound used is a compound, the dipole of which is a nitrile oxide, in the case in point 2,4,6-trimethyl-3-(2-(2-oxoimidazolidin-1-yl)ethoxy)benzonitrile oxide. The diene elastomer is a polyisoprene treated with antioxidant, Nipol 2200 grade from Nippon Zeon.

The procedure described above is carried out again in order to manufacture four other compositions, respectively NC2 to NC5.

### II.2-Examples According to the Invention:

The modified diene elastomers C1 and C2 are prepared according to the process in accordance with the invention.

Operating conditions: temperature 120° C., rotational speed of the screws 40 revolutions/min, residence time 2 min.

The diene elastomer is introduced into the extruder via the feed hopper in the strip form at a flow rate of 1.7 kg/h. At the same time, the 1,3-dipolar compound is introduced manually via the feed hopper in the powder form, so as to obtain a mean flow rate of 0.5 g/min. The modified diene elastomer C1 is recovered at the die outlet.

The procedure described above is carried out again in order to manufacture another modified diene elastomer C2.

II.3-Results:

A targeted content, a true content of 1,3-dipolar compound, a grafted content, a grafting yield and an effectiveness of the process are defined.

The targeted content is the amount of 1,3-dipolar compound, expressed in moles per 100 mol of isoprene unit, which has been weighed and introduced:
into the internal mixer in stage 1 for NC1 to NCS,
into the extruder via the feed hopper for C1 and C2;

The true content is the amount, determined by nuclear magnetic resonance (NMR) analysis, of 1,3-dipolar compound in the form grafted and not grafted to the diene elastomer:
on conclusion of stage 2 for NC1 to NC5,
at the outlet of the die for C1 and C2.

The grafted content corresponds to the amount, determined by NMR analysis, of 1,3-dipolar compound in the form grafted to the diene elastomer on conclusion of stage 2 for NC1 to NC5 or at the outlet of the die for C1 and C2.

The grafting yield is the ratio of the amount of 1,3-dipolar compound grafted to the diene elastomer to the true content.

The effectiveness of the process is the ratio of the amount of 1,3-dipolar compound grafted to the diene elastomer to the targeted content.

These quantities are determined by NMR analysis on the diene elastomers or on the compositions NC1 to NC5.

Method of Analysis by NMR:

The 1D ¹H NMR experiments use a simple pulse sequence with a tilt angle of 30°, the number of repetitions is 128 scans with a recycle delay of 5 seconds.

The two-dimensional ¹H/¹³C NMR experiments are sequences of HSQC (Heteronuclear Single Quantum Coherence) and HMBC (Heteronuclear Multiple-Bond Correlation) type for short-range (¹J) and long-range (³J)¹H/¹³C correlations respectively. The experiments are carried out at 25° C.

Two parts of the same sample are analysed:
the one crude (resulting directly from the end of the synthesis)
and the other coagulated (devoid of any free molecule, in particular of ungrafted 1,3-dipolar compound).

The chemical shifts are calibrated with respect to the protonated impurity of the CDCl₃ δ (¹H)=7.20 ppm, referenced with regard to TMS (δ (¹H)=0.06 ppm).

Scheme 1 illustrates the portions of the isoprene units modified by the grafting of the 1,3-dipolar compound, R representing the remainder of the polyisoprene chain.

The characteristic chemical shifts of the protons of the 1,3-dipolar compound grafted to the polyisoprene (IR) chain appear in Table 1.

The quantifications were carried out from the integration of the 1D ¹H NMR spectra using data acquisition software.

The broad unresolved peaks under consideration for the quantification are:
proton of 1,2-IR between 5.8 ppm and 5.6 ppm,
proton of 1,4-IR between 5.4 and 4.7 ppm,
2 protons of 3,4-IR between 4.7 and 4.5 ppm,
8 protons of the 1,3-dipolar compound (4 CH₂) between 3.9 and 3.3 ppm.

Using the integration of the 1D ¹H NMR spectrum of the crude part of the sample: the quantification of the total 1,3-dipolar compound unit in the grafted and ungrafted form can be carried out as % units as follows:

% total unit=integral ¹H total unit×100/(integral ¹H 1,4-IR unit+integral ¹H 3,4-IR unit+integral ¹H 1,2-IR unit).

Using the integration of the 1D ¹H NMR spectrum of the coagulated part of the sample: the quantification of the grafted 1,3-dipolar compound unit can be carried out as % units as follows:

% grafted unit=integral ¹H grafted unit x 100/(integral ¹H 1,4-IR unit +integral ¹H 3,4-IR unit+integral ¹H 1,2-IR unit).

For the analyses carried out on the compositions, the sample is prepared in rotors filled with the composition or the elastomer to be analysed and a deuterated solvent which makes possible the swelling, generally deuterated chloroform (CDCl₃). The amounts of sample used are adjusted so as to obtain spectra with a sufficient sensitivity and a sufficient resolution. For the analyses carried out on the modified elastomers, 25 mg of sample are dissolved in 1 ml of deuterated chloroform (CDCl₃) for the field/frequency locking.

The results appear in Table 2.

For the examples not in accordance with the invention, the true content is far below the targeted content, which clearly reflects a loss of 1,3-dipolar compound in the process. Furthermore, the grafting yields vary to a large extent since they range from 52% to 82%, which demonstrates a lack of reproducibility of the process. It may also be noted that the effectiveness of the process is low (at most 40%) if the grafting yield is calculated not on the basis of the true content of 1,3-dipolar compound but on the basis of the targeted content.

For the examples in accordance with the invention, although the true content is less than the targeted content, the grafting yields are constant and are 100%, which reflects a control of the grafting reaction in the process in accordance with the invention. Furthermore, a much better effectiveness of the process (of at least 50%) is also noted. These process performance qualities are obtained without there being crosslinking of the diene elastomer.

The use of the granules in accordance with the invention in a rubber composition makes it possible to improve the effectiveness and the reproducibility of the process for the manufacture of rubber compositions based on diene elastomer and on 1,3-dipolar compound, due to the absence of fluctuation in the degree of grafting of the diene elastomer in the process for the modification of the elastomer. As the degree of grafting does not fluctuate, the changes in properties of the rubber compositions introduced by the modification of the elastomer are more under control and thus more reproducible.

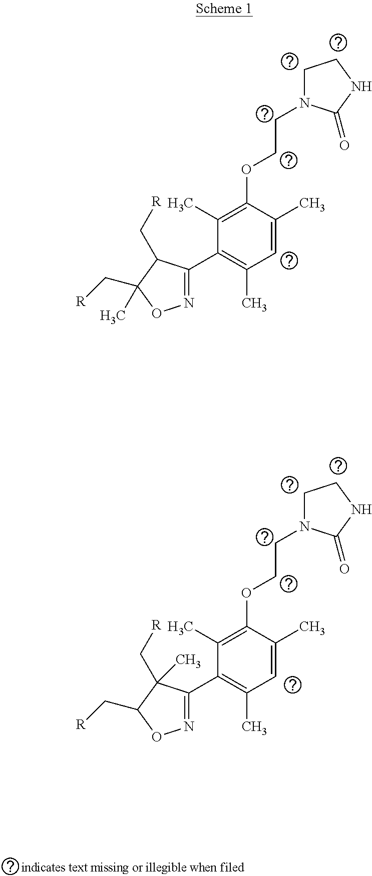

TABLE 1

| δ ¹H (ppm) | Unit |
|---|---|
| 6.81 | CH No. 5 |
| 3.39 | CH₂ No. 4 |
| 3.65 | CH₂ No. 3 |
| 3.51 | CH₂ No. 2 |
| 3.78 | CH₂ No. 1 |

TABLE 2

| | NC1 | NC2 | NC3 | NC4 | NC5 | C1 | C2 |
|---|---|---|---|---|---|---|---|
| Targeted content | 0.30 | 0.30 | 0.30 | 0.30 | 0.30 | 0.40 | 0.40 |
| (mol %) | | | | | | | |
| True content in- | 0.17 | 0.14 | 0.16 | 0.15 | 0.08 | 0.20 | 0.22 |
| troduced (mol %) | | | | | | | |
| Grafting yield | 59 | 82 | 52 | 67 | 75 | 100 | 100 |
| (%) | | | | | | | |
| Effectiveness of | 33 | 40 | 30 | 33 | 40 | 50 | 55 |
| the process (%) | | | | | | | |

1. A process for the preparation of a diene elastomer modified by a 1,3-dipolar compound by a grafting reaction, it the process comprising a stage a) of reactive extrusion of a mixture of a diene elastomer and of a 1,3-dipolar compound in a twin-screw extruder comprising a barrel, a set of two endless screws, a feed zone, a compounding zone and a die, the extrusion temperature being greater than 100° C.

2. A process according to claim 1, in which the diene elastomer and the 1,3-dipolar compound are introduced simultaneously into the feed zone of the extruder.

3. A process according to claim 1, in which the diene elastomer and the 1,3-dipolar compound are introduced separately into the extruder, the introduction of the diene elastomer being carried out in the feed zone of the extruder, the introduction of the 1,3-dipolar compound being carried out downstream of the introduction of the diene elastomer.

4. A process according to claim 1, in which the 1,3-dipolar compound is introduced into the compounding zone of the extruder.

5. A process according to claim 1, in which the extrusion temperature is between 110 and 140° C.

6. A process according to claims 1, in which the extrusion temperature in the zone ranging from the compounding zone up to the end of the set of the two screws closest to the die is between 110 and 140° C.

7. A process according to claim 1, in which the dipole of the 1,3-dipolar compound is a nitrile oxide.

8. A process according to claim 7, in which the 1,3-dipolar compound comprises a benzene ring substituted by the nitrile oxide dipole.

9. A process according to claim 8, in which the benzene ring is substituted in the position ortho to the dipole.

10. A process according to claim 1, in which the 1,3-dipolar compound contains a group containing a 5-membered dinitrogenous and carbonylated heterocycle.

11. A process according to claim 1, in which the diene elastomer is selected from the group consisting of polybutadienes, polyisoprenes, butadiene copolymers, isoprene copolymers and their mixtures.

12. A process according to claim 1, in which the diene elastomer is a polyisoprene comprising more than 90 mol% of cis-1,4 bonding.

13. A process according to claim 1, in which the diene elastomer contains an antioxidant.

14. A process according to claim 1, in which stage a) is followed by a stage of granulation of the modified diene elastomer at the outlet of the extruder.

15. A process for the preparation of a rubber composition based on a diene elastomer modified by a 1,3-dipolar compound and on a reinforcing filler which comprises the following stages:
a stage a) of reactive extrusion of a mixture of a diene elastomer and of a 1,3-dipolar compound in a twin-screw extruder comprising a barrel, a set of two endless screws, a feed zone, a compounding zone and a die in order to form a modified diene elastomer, the extrusion temperature being greater than 100° C.,
a stage of incorporation of a reinforcing filler in the modified diene elastomer by thermomechanical kneading in an internal mixer.

16. A process according to claim 15, in which a stage of granulation of the modified diene elastomer follows stage a) and precedes the stage of incorporation of the reinforcing filler.

17. A granule of diene elastomer modified by a reaction of grafting a 1,3-dipolar compound capable of being obtained by the process defined according to claim 14.

18. rubber composition comprising: a plurality of granules each being according to claim 17, and a reinforcing filler.
